(19) United States
(12) Patent Application Publication
(10) Pub. No.: US 2026/0308404 A1
(43) Pub. Date: Oct. 8, 2026

(54) INKJET INK AND INKJET RECORDING APPARATUS

(71) Applicant: KYOCERA DOCUMENT SOLUTIONS INC., OSAKA (JP)

(72) Inventor: NORIAKI OZAWA, OSAKA (JP)

(21) Appl. No.: 19/571,444

(22) Filed: Mar. 18, 2026

(30) Foreign Application Priority Data
Apr. 4, 2025 (JP) 2025-062523

(51) Int. Cl. C09D 11/322; B41J 2/155; C09D 11/037

(52) U.S. Cl. CPC C09D 11/322; B41J 2/155; C09D 11/037

(57) ABSTRACT

An inkjet ink includes: a quinacridone pigment, a pigment dispersion resin, and an aqueous medium. The pigment dispersion resin includes an adsorbed resin adsorbed on the quinacridone pigment and an unadsorbed resin that is not adsorbed on the quinacridone pigment. The unadsorbed resin has a weight average molecular weight of 5,000 or less. A ratio of the unadsorbed resin in the pigment dispersion resin is 10 mass % or less. A phosphorus concentration in a 50-fold diluted solution of a supernatant liquid obtained by centrifuging the ink at 23° C. and 140,000 rpm for 3 hours is 0.5 ppm or less.

### CROSS-REFERENCE TO RELATED PATENT APPLICATION

This application claims the benefit of Japanese Priority Patent Application JP 2025-062523 filed on Apr. 4, 2025, the entire contents of which are incorporated herein by reference.

### FIELD OF THE DISCLOSURE

The present disclosure relates to an inkjet ink including a quinacridone pigment, and an inkjet recording apparatus.

### BACKGROUND OF THE DISCLOSURE

Inkjet inks are desired to have high ejection stability when ejected from a nozzle of a recording head. There is known a technology for improving ejection stability in an inkjet ink using a quinacridone pigment.

### SUMMARY OF THE DISCLOSURE

According to an embodiment of the present disclosure, there is provided an inkjet ink, including: a quinacridone pigment; a pigment dispersion resin; and an aqueous medium.

The pigment dispersion resin includes an adsorbed resin adsorbed on the quinacridone pigment and an unadsorbed resin that is not adsorbed on the quinacridone pigment.

The unadsorbed resin has a weight average molecular weight of 5,000 or less.

A ratio of the unadsorbed resin in the pigment dispersion resin is 10 mass % or less.

A phosphorus concentration in a 50-fold diluted solution of a supernatant liquid obtained by centrifuging the ink at 23° C. and 140,000 rpm for 3 hours is 0.5 ppm or less.

### BRIEF DESCRIPTION OF THE DRAWINGS

FIG. 1 is a diagram showing an inkjet recording apparatus according to an embodiment of the present disclosure.

FIG. 2 is a diagram showing the lower surface of the recording head of the inkjet recording apparatus.

### DETAILED DESCRIPTION OF THE EXEMPLARY EMBODIMENTS

The discloser of the present application has found that inks using a quinacridone pigment tend to be unejectable due to drying in nozzles of a recording head, i.e., it is difficult to ensure an intermittent ejection property.

In view of the circumstances as described above, it is an object of the present disclosure to provide an inkjet ink that includes a quinacridone pigment and has an excellent intermittent ejection property.

An embodiment of the present disclosure will be described.

### [Inkjet Ink]

An inkjet ink according to an embodiment of the present disclosure (hereinafter, also referred to simply as an “ink”) includes a quinacridone pigment; a pigment dispersion resin; and an aqueous medium. In the ink according to this embodiment, the pigment dispersion resin includes an adsorbed resin adsorbed on the quinacridone pigment, and an unadsorbed resin that is not adsorbed on the quinacridone pigment and is free in the aqueous medium, and the quinacridone pigment and the adsorbed resin constitute the pigment dispersion. In the ink according to this embodiment, by controlling the weight average molecular weight and ratio of the unadsorbed resin and the residual amount of the phosphorus-containing catalyst used for synthesizing the quinacridone pigment, it is possible to achieve an excellent intermittent ejection property.

Specifically, in the ink according to this embodiment, the unadsorbed resin has a weight average molecular weight of 5,000 or less and the ratio of the unadsorbed resin in the pigment dispersion resin is 10 mass % or less. That is, in the ink according to this embodiment, by reducing the amount of the unadsorbed resin and reducing the weight average molecular weight of the remaining unadsorbed resin, it is possible to effectively suppress adhesion of the unadsorbed resin to the nozzle surface of the recording head. This allows the ink according to this embodiment to achieve a favorable intermittent ejection property.

Further, in the ink according to this embodiment, since substantially all phosphorus can be considered to originate from the phosphorus-containing catalyst, the amount of the phosphorus-containing catalyst can be determined from the phosphorus concentration. More specifically, in this embodiment, the amount of the unadsorbed resin in the ink is determined by the phosphorus concentration in a 50-fold diluted solution of a supernatant liquid (hereinafter, also referred to simply as a “supernatant liquid”) obtained by centrifuging the ink at 23° C. and 140,000 rpm for 3 hours. In the ink according to this embodiment, the residual amount of the phosphorus-containing catalyst that causes an intermittent ejection property to deteriorate is adjusted such that the phosphorus concentration in the 50-fold diluted solution of the supernatant liquid is 0.5 ppm or less.

### [Quinacridone Pigment]

Examples of the quinacridone pigment that can be used in the ink according to this embodiment include quinacridone magenta, quinacridone red, quinacridone orange, quinacridone gold, and quinacridone violet.

An example of the method of synthesizing the quinacridone pigment will be described. The quinacridone pigment is, for example, a compound represented by the following formula (D). The quinacridone pigment is synthesized by, for example, carrying out the reactions represented by reaction formulae (r-a), (r-b), and (r-c).

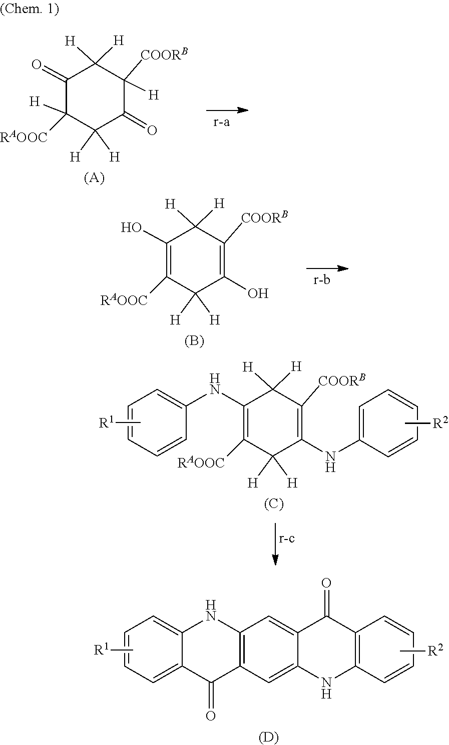

In the formulae (A), (B), (C), and (D), R^{A}, R^{B}, R¹, and R² each independently represent a monovalent group. Hereinafter, the “reactions represented by the reaction formulae (r-a), (r-b), and (r-c)” will be respectively referred to as “reactions (r-a), (r-b), and (r-c)” in some cases. Further, the “compounds represented by the formulae (A), (B), (C), and (D)” will be respectively referred to as “compounds (A), (B), (C), and (D)” in some cases. In the case where R¹ and R² each represent a methyl group, the compound (D) is C.I. Pigment Red 122. In the case where R¹ and R² each represent a hydrogen atom, the compound (D) is C.I. Pigment Violet 19.

In the reaction (r-a), the compound (B) is obtained from the compound (A). Subsequently, in the reaction (r-b), 1 molar equivalent of compound (B) and 2 molar equivalents of aniline derivative are reacted with each other to obtain 1 molar equivalent of compound (C). Subsequently, in the reaction (r-c), the compound (C) is oxidized to obtain an oxide of the compound (C). Subsequently, in the reaction (r-c), the oxide of the compound (C) is hydrolyzed to obtain a hydrolysate. Subsequently, in the reaction (r-c), the hydrolysate is subjected to a dehydration ring-closure reaction using a phosphorus-containing catalyst to obtain the compound (D). The reaction temperature of the dehydration ring-closure reaction is, for example, 90° C. or more and 120° C. or less. The reaction time of the dehydration ring-closure reaction is, for example, 1 hour or more and 2 hours or less.

The phosphorus-containing catalyst used in the reaction (r-c) is, for example, at least one selected from the group consisting of polyphosphoric acid and a derivative thereof. Examples of the derivative of polyphosphoric acid include polyphosphoric acid ester, more specifically, polyphosphoric acid alkylester. As the polyphosphoric acid alkylester, polyphosphoric acid methylester is favorable.

After carrying out the above reaction (r-c), the quinacridone pigment may be subjected to, for example, a solvent treatment process (hereinafter, referred to as a process A in some cases) and a post-treatment process (hereinafter, referred to as a process B in some cases). The process A is a process of decreasing the particle size, and high colorability and high saturation are achieved. The process B is a process of suppressing the agglomeration of quinacridone pigments due to the decrease in the particle size in the process A. By carrying out the process A and the process B, a fine quinacridone pigment having excellent dispersibility and preservation stability can be obtained.

In the process A, the quinacridone pigment is treated with a solvent. The quinacridone pigment before the process A is carried out is referred to also as a crude, and is an agglomerated particle with a low degree of crystallization. The quinacridone pigment before the process A is carried out has insufficient colorability. In this regard, by carrying out the process A, the crystal growth of the quinacridone pigment and the micronization of the quinacridone pigment are promoted. By promoting the crystallization and micronization of the quinacridone pigment, the colorability and saturation of the quinacridone pigment are made suitable. More specifically, by carrying out the process A, the crude of the quinacridone pigment is converted into the β-type or γ-type crystal of the quinacridone pigment, and the colorability and saturation of the quinacridone pigment are improved. Examples of the method of treating the quinacridone pigment include a method of kneading a quinacridone pigment and a solvent using a kneader (e.g., a salt milling kneader). The temperature and time for treating the quinacridone pigment are not particularly limited, and only need to be set appropriately to achieve a desired particle diameter and particle size distribution of the quinacridone pigment. The process A may be carried out while heating the quinacridone pigment. Further, in the process A, an inorganic base (more specifically, sodium hydroxide, potassium hydroxide, or the like) may be added as a grinding aid as necessary. A kneaded product of the quinacridone pigment obtained in the process A is washed with water or a solvent as necessary to obtain, for example, a wet cake shape.

In the process B, the kneaded product of the quinacridone pigment obtained in the process A is post-treated. By carrying out the process B, the agglomeration of the micronized quinacridone pigment is suppressed. By carrying out the process B, favorable dispersibility and preservation stability can be imparted to the quinacridone pigment in addition to the colorability and saturation of the quinacridone pigment imparted in the process A. As the post-treatment method, for example, a method of removing the solvent from the kneaded product of the quinacridone pigment to separate the quinacridone pigment is adopted. Examples of the method of separating the quinacridone pigment include filtration, drying, and distilling off of the solvent using a rotary evaporator. In the case where the solvent is distilled off, the temperature for distilling off the solvent is, for example, a temperature of the boiling point of the solvent or more.

### (Pigment Dispersion Resin)

The pigment dispersion resin is favorably fine particles of a resin having a molecular weight of several ten thousand from the viewpoint of improving the quality of the image to be formed on the recording medium. Further, the acid value of the pigment dispersion resin is favorably 150 mg KOH/g or more and 300 mg KOH/g or less. Note that the acid value of the pigment dispersion resin is obtained by measurement in accordance with JIS K 0070:1992 (Test methods for acid value, saponification value, ester value, iodine value, hydroxyl value and unsaponifiable matter of chemical products).

As the pigment dispersion resin, a known pigment dispersion resin can be appropriately selected and used. The pigment dispersion resin may be either a random polymer or a block polymer. Specific examples of the pigment dispersion resin include polyester, polyurethane, (meth)acrylic acid, a styrene-(meth)acrylic acid copolymer, a styrene-maleic acid copolymer, a styrene-maleic acid half ester copolymer, a vinyl naphthalene-(meth)acrylic acid copolymer, and a vinyl naphthalene-maleic acid copolymer. The styrene-(meth)acrylic acid copolymer is a resin including a unit derived from styrene and a unit derived from (meth)acrylic acid, (meth)acrylic acid ester, or methacrylic acid ester. Examples of the styrene-(meth)acrylic acid copolymer include a styrene-(meth)acrylic acid-(meth)acrylic acid alkyl ester copolymer, a styrene-methacrylic acid-methacrylic acid alkyl ester-(meth)acrylic acid alkyl ester copolymer, a styrene-(meth)acrylic acid copolymer, a styrene-maleic acid-(meth)acrylic acid alkyl ester copolymer, a styrene-methacrylic acid copolymer, and a styrene-methacrylic acid alkyl ester copolymer. Of these pigment dispersion resins, a styrene-(meth)acrylic acid copolymer is favorable because it is easy to prepare and has an excellent dispersion effect of the quinacridone pigment.

In the ink according to this embodiment, in order to sufficiently achieve the above effect of the pigment dispersion resin, the content of the pigment dispersion resin is favorably 0.5 mass % or more. Further, in the ink according to this embodiment, in order to achieve high dispersion stability, the content of the pigment dispersion resin is favorably 7 mass % or less.

### (Aqueous Medium)

The aqueous medium is a medium including water. The aqueous medium may function as a solvent or a dispersion medium. Examples of the aqueous medium include a medium including water and an organic solvent. In order to enhance the compatibility with water, the organic solvent included in the aqueous medium is favorably a water-soluble organic solvent. The water-soluble organic solvent is an organic solvent that is uniformly mixed with water at an arbitrary ratio.

Examples of the water-soluble organic solvent include a glycol compound, a triol compound, a glycol ether compound, a lactam compound, a nitrogen-containing compound, an acetate compound, γ-butyrolactone, thiodiglycol, and dimethylsulfoxide.

Examples of the glycol compound include ethylene glycol, 1,3-propanediol, propylene glycol, 1,3-butanediol, 1,2-pentanediol, 1,5-pentanediol, 1,2-hexanediol, 1,2-octanediol, 1,8-octanediol, 3-methyl-1,3-butanediol, 3-methyl-1,2-pentanediol, 3-methyl-1,5-pentanediol, 2,4-diethyl-1,5-pentanediol, 2-butyl-2-ethyl-1,3-propanediol, diethylene glycol, dipropylene glycol, trimethylene glycol, triethylene glycol, tripropylene glycol, tetraethylene glycol, 2-ethyl-1,2-hexanediol, and thiodiglycol. As the glycol compound, 3-methyl-1,5-pentanediol is favorable.

Examples of the triol compound include glycerin, 1,2,3-butanetriol, and 1,2,6-hexanetriol. As the triol compound, glycerin is favorable.

Examples of the glycol ether compound include diethylene glycol diethyl ether, diethylene glycol monoethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether. As the glycolether compound, triethylene glycol monobutylether is favorable.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethyl ether acetate.

As the aqueous medium, a mixed solvent of water, triethylene glycol monobutyl ether, 3-methyl-1,5-pentanediol, and glycerin is favorable.

In the ink according to this embodiment, the content of the water-soluble organic solvent is favorably 15 mass % or more and 35 mass % or less. In the ink according to this embodiment, the content of the aqueous medium is favorably 35 mass % or more and 55 mass % or less.

### (Other Components)

In the ink according to this embodiment, components other than the above may be blended as necessary. For example, in the ink according to this embodiment, a surfactant may be blended. The surfactant has the effect of enhancing the wettability of the ink on a recording medium and the effect of enhancing the compatibility and dispersion stability of each component included in the ink. Examples of the surfactant blended in the ink according to this embodiment include an anionic surfactant, a cationic surfactant, a non-ionic surfactant, and an amphoteric surfactant. The surfactant is favorably a non-ionic surfactant. The non-ionic surfactant is favorably a surfactant having an acetylene bond, more favorably a surfactant having an acetylene glycol structure or an acetylene alcohol structure.

Further, in the ink according to this embodiment, various additives such as a penetrating agent, a dissolution stabilizer, an anti-drying agent, an antioxidant, a viscosity adjustor, a pH adjuster, a neutralizer, and an antifungal agent may be blended as necessary in addition to the surfactant.

### [Inkjet Recording Apparatus]

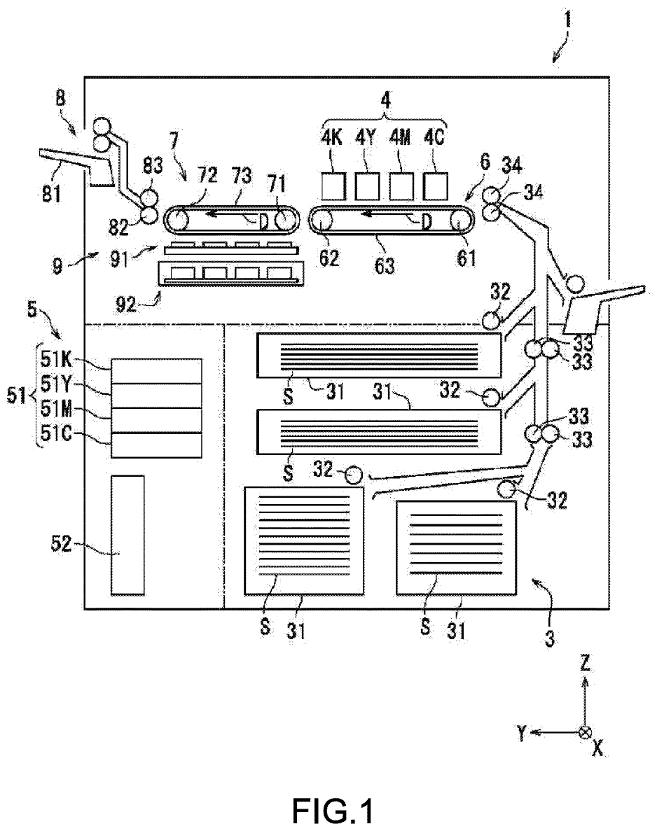

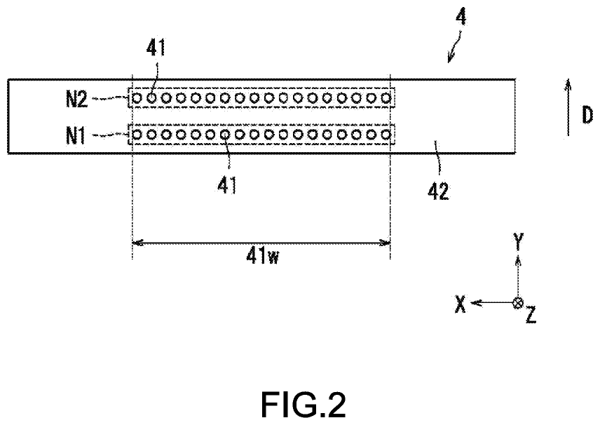

An inkjet recording apparatus 1 according to an embodiment of the present disclosure forms an image on a recording medium using the inkjet ink according to the above embodiment. FIG. 1 is a diagram showing the inkjet recording apparatus 1. The X-axis, Y-axis, and Z-axis shown in FIG. 1 and FIG. 2 described below define a common Cartesian coordinate system. Note that FIG. 1 and FIG. 2 schematically show the respective components mainly for ease of understanding, and the size, number, and the like of the illustrated components differ from the actual ones in some cases.

The inkjet recording apparatus 1 includes a paper feed unit 3, a first recording head 4C, a second recording head 4M, a third recording head 4Y, a fourth recording head 4K, a liquid housing unit 5, a first conveying unit 6, a second conveying unit 7, an output unit 8, and a maintenance unit 9. Hereinafter, in the case where there is no need to distinguish between the first recording heads 4C to the fourth recording head 4K, they will be referred to simply as “recording heads 4” in some cases.

The paper feed unit 3 includes a plurality of paper feed cassettes 31, a plurality of pick-up rollers 32, a plurality of conveying rollers 33, and a resist roller pair 34. Recording media S are stacked and housed in the paper feed cassette 31. The pick-up roller 32 takes out the recording media S housed in the paper feed cassette 31 one by one. The conveying roller 33 conveys the recording medium S taken out by the pick-up roller 32. The resist roller pair 34 causes the recording medium S conveyed by the conveying rollers 33 to be left in place temporarily and then supplies it to the first conveying unit 6 at predetermined timing.

The recording heads 4 are disposed above a first conveyor belt 63. The first recording head 4C to the fourth recording head 4K are arranged in this order in a conveying direction D of the recording medium S. Each of the first recording head 4C to the fourth recording head 4K is disposed at the same height. The first recording head 4C to the fourth recording head 4K are filled with inks of four different colors (e.g., cyan, magenta, yellow, and black). The ink deposited in the second recording head 4M is the ink according to this embodiment, which is magenta. The recording heads 4 eject the respective inks to the recording medium S. Of the recording heads 4, the second recording head 4M ejects the ink according to the above embodiment, which is magenta, onto the recording medium S. As a result, an image (e.g., a color image) is formed on the recording medium S conveyed by the first conveyor belt 63.

In the inkjet recording apparatus 1, since the ink according to the above embodiment is used, the intermittent ejection property of the ink from the second recording head 4 is excellent.

The liquid housing unit 5 includes a first ink tank 51C, a second ink tank 51M, a third ink tank 51Y, a fourth ink tank 51K, and a cleaning solution tank 52. Hereinafter, in the case where there is no need to distinguish between the first ink tank 51C to the fourth ink tank 51K, they will be referred to simply as “ink tanks 51” in some cases. In the first ink tank 51C to the fourth ink tank 51K, inks of different four colors (e.g., cyan, magenta, yellow, and black) are housed. The ink housed in the second ink tank 51M is the ink according to this embodiment, which is magenta. The first ink tank 51C to the fourth ink tank 51K respectively supply the inks to the first recording head 4C to the fourth recording head 4K. The cleaning solution tank 52 supplies a cleaning solution to a liquid impregnated body 91.

The first conveying unit 6 is disposed downstream of the paper feed unit 3 in the conveying direction D of the recording medium S. The first conveying unit 6 includes a first driven roller 61, a first drive roller 62, and the first conveyor belt 63. The first drive roller 62 is disposed downstream of the first driven roller 61 in the conveying direction D of the recording medium S. The first conveyor belt 63 is an endless belt stretched over the first driven roller 61 and the first drive roller 62. The first drive roller 62 is driven to rotate in the counterclockwise direction in FIG. 1. As a result, the first drive roller 62 drives the first conveyor belt 63 in a driven manner. In this way, the first conveyor belt 63 conveys the recording medium S supplied from the paper feed unit 3 to the second conveying unit 7 in the conveying direction D. The first driven roller 61 rotates in accordance with the first drive roller 62 via the first conveyor belt 63.

The second conveying unit 7 is disposed downstream of the first conveying unit 6 in the conveying direction D of the recording medium S. The second conveying unit 7 includes a second driven roller 71, a second drive roller 72, and a second conveyor belt 73. The second drive roller 72 is disposed downstream of the second driven roller 71 in the conveying direction D of the recording medium S. The second conveyor belt 73 is an endless belt stretched over the second driven roller 71 and the second drive roller 72. The second drive roller 72 is driven to rotate in the counterclockwise direction in FIG. 1. As a result, the second drive roller 72 drives the second conveyor belt 73 in a driven manner. In this way, the second conveyor belt 73 conveys the recording medium S conveyed from the first conveying unit 6 to the output unit 8 in the conveying direction D. The second driven roller 71 rotates in accordance with the second drive roller 72 via the second conveyor belt 73.

The output unit 8 is disposed downstream of the second conveying unit 7 in the conveying direction D of the recording medium S. The output unit 8 includes an output tray 81, an output drive roller 82, and an output driven roller 83. The output drive roller 82 and the output driven roller 83 are pressed against each other at positions facing each other. The output drive roller 82 is driven to rotate in the counterclockwise direction in FIG. 1. The output driven roller 83 rotates in accordance with rotation of the output drive roller 82. In this way, the output drive roller 82 and the output driven roller 83 output the recording medium S conveyed from the second conveying unit 7 to the output tray 81. The output recording medium S is placed on the output tray 81.

The maintenance unit 9 includes the liquid impregnated body 91 and a cleaning member 92. The liquid impregnated body 91 and the cleaning member 92 are provided so as to be movable between a position below the second conveying unit 7 and a position in contact with an ejection surface 42 (see FIG. 2) of the recording head 4. The liquid impregnated body 91 is impregnated with the cleaning solution. The liquid impregnated body 91 comes into contact with the ejection surface 42 (see FIG. 2) of the recording head 4 to supply the cleaning solution to the ejection surface 42. The liquid impregnated body 91 is, for example, a sponge, a non-woven fabric, or a water-absorbent sheet. The cleaning member 92 wipes the ejection surface 42 of the recording head 4. As a result, the ink adhering to the ejection surface 42 is cleaned. The cleaning member 92 is, for example, a rubber wiper.

Next, the recording head 4 will be further described with reference to FIG. 2. FIG. 2 is a diagram showing the lower surface of the recording head 4 shown in FIG. 1.

As shown in FIG. 2, the recording head 4 includes a first nozzle column N1, a second nozzle column N2, and the ejection surface 42. For ease of understanding, in FIG. 2, each of the first nozzle column N1 and the second nozzle column N2 is surrounded by a broken line. Each of the first nozzle column N1 and the second nozzle column N2 includes a plurality of nozzles 41. The nozzle 41 ejects an ink onto the recording medium S. The nozzle 41 opens into the ejection surface 42. The first nozzle column N1 and the second nozzle column N2 are arranged in the conveying direction D of the recording medium S. In each of the first nozzle column N1 and the second nozzle column N2, the plurality of nozzles 41 is provided at intervals in a direction orthogonal to the conveying direction D of the recording medium S. The recording head 4 is, for example, a line type recording head.

A width 41w of each of the first nozzle column N1 and the second nozzle column N2 (that is, the width of the region where recording is possible by the recording head 4) is equal to or wider than the width of the recording medium S. For this reason, the recording head 4 is capable of recording an image on the recording medium S conveyed on the first conveyor belt 63 while being fixed. That is, the inkjet recording apparatus 1 employs a single-pass system that is a system in which shuttle movement is not performed. Since the inkjet recording apparatus 1 according to the second embodiment includes such a recording head 4, printing can be performed at high speed as compared with an inkjet recording apparatus that includes a serial head.

Note that the inkjet recording apparatus 1 does not necessarily need to have the above configuration. The inkjet recording apparatus 1 may adopt a multi-pass system. Further, in the inkjet recording apparatus 1, the number of nozzles 41, the intervals between the nozzles 41, and the positional relationship between the nozzles 41 in the first recording head 4C to the fourth recording head 4K may be appropriately set in accordance with the specifications of the apparatus. Further, the arrangement order of the first recording head 4C to the fourth recording head 4K in the inkjet recording apparatus 1 is not limited to that shown in FIG. 1, and may be other order. Further, the number of recording heads 4 in the inkjet recording apparatus 1 is not limited to four, and may be one to three, or five or more.

### Example

Inks were prepared and evaluated as Examples of the present disclosure. Note that the following Examples are merely illustrative examples of the present disclosure, and the present disclosure is not limited to the configurations of the following Examples.

### (Preparation of Ink)

In Examples 1 to 3, first, a pigment dispersion liquid was prepared. The pigment dispersion liquid was prepared by blending a quinacridone pigment, a pigment dispersion resin, sodium hydroxide, OLFINE (registered trademark) E1010, and water such that the content shown in Table 1 was achieved, and performing dispersion treatment thereon.

TABLE 1

| Component | Content (mass %) |
|---|---|
| Quinacridone pigment | 15 |
| Pigment dispersion resin | 1.0 |
| Sodium hydroxide | 0~1.0 |
| OLFINE E1010 | 0.5 |
| Water | Remainder |

Sodium hydroxide was blended as a neutralizer for neutralizing the pigment dispersion resin. OLFINE (registered trademark) E1010 was blended as a dispersant for enhancing the dispersibility of the quinacridone pigment in the aqueous medium and is a non-ionic surfactant manufactured by Nissin Chemical Co., Ltd. In all Examples, C.I. Pigment Red 112 was used as the quinacridone pigment and a methacrylic acid-methyl methacrylate-butyl acrylate-styrene copolymer (molecular weight: 20,000, acid value: 100 mg KOH/g) was used as the pigment dispersion resin.

The pigment dispersion liquid was prepared by mixing the above components by wet dispersion treatment using a media-type wet disperser. Examples of the media-type wet disperser include a wet disperser (more specifically, “Nano Grain Mill” manufactured by ASADA IRON WORKS. CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using a media-type wet disperser, media (e.g., zirconia beads having a diameter of 0.5 mm) were set in a vessel and the ejection rate was controlled to adjust the average particle diameter of the pigment dispersion in which a dispersant was adhered to the quinacridone pigment dispersed in water to 70 to 130 nm. The particle size distribution of the pigment dispersion was measured using “Zetasizer Nano” manufactured by Sysmex Corporation with a diluted solution obtained by diluting the pigment dispersion liquid 300 times with ion exchanged water. In the wet dispersion, adjusting the bead diameter of the media allows the amount of the unadsorbed resin to be adjusted, for example.

Ultrafiltration was performed on the pigment dispersion liquid to reduce the amounts of the unadsorbed resin and the phosphorus-containing catalyst in the ink. The ultrafiltration removes at least part of the unadsorbed resin and the phosphorus-containing catalyst. The ultrafiltration was performed by a vibratory ultrafiltration method using a pencil type module UF film “AHP-0013D” (manufactured by Asahi Kasei Corporation). In the ultrafiltration, the amounts of the unadsorbed resin and the phosphorus-containing catalyst in the ink were adjusted by varying the circulation time. Through the ultrafiltration, a liquid containing the unadsorbed resin and the phosphorus-containing catalyst as filtrate is discharged and a liquid containing the components of the pigment dispersion liquid other than the unadsorbed resin and the phosphorus-containing catalyst circulates again as a recovered liquid. By adding the same amount of water as that of the discharged filtrate to the recovered liquid, the solid content concentration of the pigment dispersion liquid can be maintained at a constant level.

Next, inks according to Examples were prepared. The inks according to Examples were prepared by blending the above pigment dispersion liquid, SURFYNOL (registered trademark) 420, triethylene glycol monobutyl ether, glycerin, and water such that the content shown in Table 2 was achieved. SURFYNOL (registered trademark) 420 is a surfactant manufactured by Nissin Chemical Co., Ltd. Triethylene glycol monobutyl ether and glycerin are each a water-soluble organic solvent.

TABLE 2

| Component | Content (mass %) |
|---|---|
| Pigment dispersion liquid | 40.0 |
| SURFYNOL 420 | 0.3 |
| Triethylene glycol monobutyl ether | 20.0 |
| Glycerin | 5.0 |
| Water | Remainder |

In the preparation of the inks according to Examples, the components shown in Table 2 were added in order while stirring the solvent using a stirrer. Further, each ink after stirring was filtered using a filter having a pore size of φ5 μm. In this way, it is possible to reduce the amounts of foreign substances, dirt, coarse particles, and the like included in the ink.

### (Analysis of Ink)

### Centrifugal Treatment

2 g of the ink sealed in a container was centrifuged at the rotation speed of 140,000 rpm (corresponding to the centrifugal force of 1,050,000 G) for 3 hours under an environment with a temperature of 23° C. using an ultracentrifuge (“himac (registered trademark) CS150FNX” manufactured by Eppendorf Himac Technologies Co., Ltd., rotor: S140AT). This precipitated the pigment dispersion included in the ink, thereby obtaining a supernatant liquid.

### Ratio of Unadsorbed Resin

The supernatant liquid obtained from 2 g of the ink was dried at 60° C. for 24 hours under a reduced pressure. Then, by measuring the weight after drying under a reduced pressure, the mass of the unadsorbed resin included in the 2 g of the ink was obtained. Then, the ratio (mass %) of the unadsorbed resin in the pigment dispersion resin was obtained from the obtained mass of the unadsorbed resin and the theoretical value of the mass of the pigment dispersion resin included in the 2 g of the ink.

### Weight Average Molecular Weight of Unadsorbed Resin

The weight average molecular weight of the unadsorbed resin was measured in accordance with the following conditions using gel permeation chromatography (“HLC-8020GPC” manufactured by TOSOH CORPORATION).
Column: “TSKgel SuperMultiporeHZ-H” manufactured by TOSOH CORPORATION (semi-microcolumn of 4.6 mm I.D.×15 cm)
Number of columns: 3
Eluent: tetrahydrofuran
Flow rate: 0.35 mL/min
Sample injection amount: 10 μL
Measurement temperature: 40° C.
Detector: IR detector

Note that calibration curves were created by selecting 7 types of F-40, F-20, F-4, F-1, A-5000, A-2500, and A-1000 and n-propylbenzene from TSKgel standard polystyrene manufactured by TOSOH CORPORATION.

### Phosphorus Concentration

The supernatant liquid was collected using a 1 ml syringe. The collected supernatant liquid was diluted 50 times with water, and this was used as a measurement sample. The measurement sample was measured by inductively coupled plasma (ICP) light emission analysis. The phosphorus concentration was obtained from the measurement value on the basis of the calibration curve. The calibration curve was created on the basis of the results obtained by measuring samples with phosphorus concentrations of 0.1 ppm, 0.5 ppm, and 1 ppm prepared using a phosphate ion standard solution PO43-1000 (manufactured by FUJIFILM Wako Pure Chemical Corporation) by ICP light emission analysis. As an ICP light emission analyzer, “ICPS-8100” (manufactured by SHIMADZU CORPORATION) was used.

### (Evaluation of Ink)

For the inks according to Examples, the intermittent ejection property was evaluated. For the evaluation of the intermittent ejection property, first, an image of a 1-dot line was formed on a recording medium with the ink to be evaluated with the ejection rate per nozzle adjusted to 3.5 pL using a recording head. After that, using the recording head left to stand at 40° C. for 3 hours, the same operation of forming an image of a 1-dot line on a recording medium with the ink to be evaluated was performed again. Inks that formed images of equivalent quality to those formed before being left to stand were evaluated to “Pass” (Grade A), and inks that failed to form images of equivalent quality to those formed before being left to stand were evaluated to “Fail” (Grade B).

### Example 1

In Example 1, ink samples 1 to 6 were prepared by varying the circulation time of ultrafiltration during the preparation of the pigment dispersion liquid, and the intermittent ejection property was evaluated for the samples 1 to 6. Note that in all of the samples 1 to 6, the ejection rate during the preparation of the pigment dispersion liquid was set to 150 g/min. Table 3 shows the circulation time of ultrafiltration, the weight average molecular weight of the unadsorbed resin, the ratio of the unadsorbed resin in the pigment dispersion resin, the phosphorus concentration, and the evaluation results of the intermittent ejection property for the samples 1 to 6. In all of the samples 1 to 5 in which the weight average molecular weight of the unadsorbed resin is 5,000 or less, the ratio of the unadsorbed resin in the pigment dispersion resin is 10 mass % or less, and the phosphorus concentration is 0.5 ppm or less, the intermittent ejection property was evaluated to “Pass.” On the other hand, in the sample 6 in which the circulation time of ultrafiltration is short, the ratio of the unadsorbed resin in the pigment dispersion resin exceeds 10 mass %, and the phosphorus concentration exceeds 0.5 ppm, the intermittent ejection property was evaluated to “Fail.”

TABLE 3

| | | Sample | | | | | |
|---|---|---|---|---|---|---|---|
| | | 1 | 2 | 3 | 4 | 5 | 6 |
| Circulation time (h) for ultrafiltration | | 5.0 | 4.5 | 4.0 | 3.7 | 3.0 | 2.5 |
| Unadsorbed resin | Weight average | 3000 | 2000 | 4000 | 4500 | 4900 | 5000 |
| | molecular weight | | | | | | |
| | Ratio (mass %) | 8 | 7 | 7 | 7 | 9 | 11 |

| | | | | | | |
|---|---|---|---|---|---|---|
| Phosphorus concentration (ppm) | 0.02 | 0.10 | 0.25 | 0.35 | 0.50 | 0.70 |
| Evaluation for intermittent ejection | A | A | A | A | A | B |
| property | | | | | | |

### Example 2

In Example 2, the ultrafiltration during the preparation of the pigment dispersion liquid was performed in two stages: first ultrafiltration and second ultrafiltration to be performed after the first ultrafiltration, ink samples 7 to 10 were prepared by varying the circulation time of the first ultrafiltration and the second ultrafiltration, and the intermittent ejection property was evaluated for the samples 7 to 10. Table 4 shows the circulation time of the first ultrafiltration, the circulation time of the second ultrafiltration, the weight average molecular weight of the unadsorbed resin, the ratio of the unadsorbed resin in the pigment dispersion resin, the phosphorus concentration, and the evaluation results of the intermittent ejection property for the samples 7 to 10. In all of the samples 7 to 9 in which the weight average molecular weight of the unadsorbed resin is 5,000 or less, the ratio of the unadsorbed resin in the pigment dispersion resin is 10 mass % or less, and the phosphorus concentration is 0.5 ppm or less, the intermittent ejection property was evaluated to “Pass.” On the other hand, in the sample 10 in which the weight average molecular weight of the unadsorbed resin exceeds 5,000, the intermittent ejection property was evaluated to “Fail.” The evaluation results of the intermittent ejection property in Example 2 showed that performing the ultrafiltration in two stages tended to make it more difficult to remove the unadsorbed resin with a large weight average molecular weight. In particular, it was found that a short circulation time of the first ultrafiltration is disadvantageous from the viewpoint of removing the unadsorbed resin with a large weight average molecular weight.

TABLE 4

| | | Sample | | | |
|---|---|---|---|---|---|
| | | 7 | 8 | 9 | 10 |
| Circulation time (h) for first ultrafiltration | | 2.0 | 2.0 | 1.5 | 1.0 |
| Circulation time (h) for second ultrafiltration | | 2.0 | 3.0 | 3.0 | 3.0 |
| Unadsorbed resin | Weight average molecular weight | 3000 | 2000 | 4000 | 5300 |
| | Ratio (mass %) | 8 | 7 | 7 | 8 |

| | | | | |
|---|---|---|---|---|
| Phosphorus concentration (ppm) | 0.35 | 0.30 | 0.33 | 0.35 |
| Evaluation for intermittent ejection property | A | A | A | B |

### Example 3

In Example 3, ink samples 11 to 15 were prepared by varying the ejection rate during the preparation of the pigment dispersion liquid, and the intermittent ejection property was evaluated for the samples 11 to 15. Note that in all of the samples 11 to 15, the ultrafiltration during the preparation of the pigment dispersion liquid was performed only once with the circulation time of 3.5 hours. Table 5 shows the ejection rate, the weight average molecular weight of the unadsorbed resin, the ratio of the unadsorbed resin in the pigment dispersion resin, the phosphorus concentration, and the evaluation results of the intermittent ejection property for the samples 11 to 15. In all of the samples 11 to 14 in which the weight average molecular weight of the unadsorbed resin is 5,000 or less, the ratio of the unadsorbed resin in the pigment dispersion resin is 10 mass % or less, and the phosphorus concentration is 0.5 ppm or less, the intermittent ejection property was evaluated to “Pass.” On the other hand, in the sample 15 in which the ejection rate is large, i.e., the dispersion time is short, and the ratio of the unadsorbed resin in the pigment dispersion resin exceeds 10 mass %, the intermittent ejection property was evaluated to “Fail.”

TABLE 5

| | | Sample | | | | |
|---|---|---|---|---|---|---|
| | | 11 | 12 | 13 | 14 | 15 |
| Ejection rate (g/mm) | | 200 | 250 | 300 | 350 | 400 |
| Unadsorbed resin | Weight average | 3000 | 2000 | 4000 | 4200 | 4700 |
| | molecular weight | | | | | |
| | Ratio (mass %) | 3 | 4 | 8 | 10 | 13 |

| | | | | | |
|---|---|---|---|---|---|
| Phosphorus concentration (ppm) | 0.35 | 0.30 | 0.25 | 0.35 | 0.33 |
| Evaluation for intermittent ejection | A | A | A | A | B |
| property | | | | | |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a quinacridone pigment;
a pigment dispersion resin; and
an aqueous medium,
the pigment dispersion resin including an adsorbed resin adsorbed on the quinacridone pigment and an unadsorbed resin that is not adsorbed on the quinacridone pigment,
the unadsorbed resin having a weight average molecular weight of 5,000 or less,
a ratio of the unadsorbed resin in the pigment dispersion resin being 10 mass % or less,
a phosphorus concentration in a 50-fold diluted solution of a supernatant liquid obtained by centrifuging the ink at 23° C. and 140,000 rpm for 3 hours being 0.5 ppm or less.

2. An inkjet recording apparatus, comprising:
a conveying unit that conveys a recording medium; and
a line type recording head that ejects an ink onto the recording medium,
the ink including the inkjet ink according to claim 1.
